(19) United States
(12) Patent Application Publication
(10) Pub. No.: US 2026/0137226 A1
(43) Pub. Date: May 21, 2026

(54) Combination Mailbox and Storage Locker Device

(71) Applicant: Alexander Gagliano, Lebanon, OH (US)

(72) Inventor: Alexander Gagliano, Lebanon, OH (US)

(21) Appl. No.: 19/373,851

(22) Filed: Oct. 30, 2025

Related U.S. Application Data
(60) Provisional application No. 63/720,834, filed on Nov. 15, 2024.

(51) Int. Cl. A47G 29/16; A47G 29/14; A47G 29/30; E05B 49/00

(52) U.S. Cl. CPC A47G 29/16; A47G 29/141; A47G 29/30; E05B 49/00; A47G 2029/148; A47G 2029/149

(57) ABSTRACT

A combination mailbox and storage locker device is provided that is designed to securely store mail and packages for homeowners and businesses. The device comprises a locker body, which can be configured in above ground or underground embodiments. A modular mailbox top attaches to the locker body and includes a mail slot with an angled orientation for secure letter delivery, directing items into a secondary compartment within the locker body. Larger packages are placed in the main compartment via a hinged, lockable lid, which may feature motorized hydraulic arms for automated operation. The lid is secured to the locker body via an electronic locking mechanism with keypad control, and optional motion-sensing cameras that provide live feeds and notifications through a mobile application. The device is powered by an adjustable solar panel with an internal battery, ensuring functionality in all lighting conditions.

### CROSS-REFERENCE TO RELATED APPLICATION

The present application claims priority to, and the benefit of, U.S. Provisional Application No. 63/720,834, which was filed on Nov. 15, 2024, and is incorporated herein by reference in its entirety.

### FIELD OF THE INVENTION

The present invention relates generally to the field of mailboxes and package lockers. More specifically, the present invention relates to a combination mailbox and storage locker device designed to securely store mail and packages through a modular mailbox top with a mail slot directing items into a secondary compartment within a locker body having a lockable, motorized lid for larger packages. Accordingly, the present disclosure makes specific reference thereto. Nonetheless, it is to be appreciated that aspects of the present invention are also equally applicable to other like applications, devices, and methods of manufacture.

### BACKGROUND

The increasing popularity of online shopping has led to a significant rise in home package deliveries, which in turn has raised concerns about the security of delivered items. Package theft has become a common issue, particularly in urban and suburban areas, where packages left unattended are often targeted by thieves. This issue affects not only the financial interests of consumers but also their sense of security and trust in delivery services. Furthermore, delivery personnel face challenges such as navigating unsafe conditions during package drop-offs, which include aggressive pets, inclement weather, and uneven or hazardous driveways. These concerns highlight the need for an effective solution that can secure delivered items while simultaneously protecting delivery personnel and ensuring their safety. Traditional mailboxes and storage solutions lack the necessary security features to address these challenges adequately. Thus, there is a growing demand for innovative solutions that combine secure storage, ease of use, and enhanced safety measures

Therefore, there exists a long-felt need in the art for an improved package locker that provides secure storage for mail and packages to prevent theft. There also exists a long-felt need in the art for an improved package locker that enhances the safety and convenience of delivery personnel. Moreover, there exists a long-felt need in the art for an improved package locker that incorporates advanced security technologies to allow real-time monitoring and controlled access.

The subject matter disclosed and claimed herein, in one embodiment thereof, comprises a combination mailbox and storage locker device. The device is designed to securely store mail and packages for homeowners and businesses. The device comprises a locker body, which can be configured in above ground or underground embodiments. A modular mailbox top attaches to the locker body and includes a mail slot with an angled orientation for secure letter delivery, directing items into a secondary compartment within the locker body. Larger packages are placed in the main compartment via a hinged, lockable lid, which may feature motorized hydraulic arms for automated operation. The lid is secured to the locker body via an electronic locking mechanism with keypad control, and optional motion-sensing cameras that provide live feeds and notifications through a mobile application. The device is powered by an adjustable solar panel with an internal battery, ensuring functionality in all lighting conditions.

In this manner, the combination mailbox and storage locker device of the present invention accomplishes all the forgoing objectives and provides a secure and versatile solution for mail and package storage. More specifically, the storage locker that ensures the protection of packages against theft and environmental factors. The integration of an electronic keypad, motion-sensing camera, and mobile application enables secure access, real-time monitoring, and delivery notifications. Additionally, the modular design and customizable components enhance adaptability to various aesthetic and functional preferences. By addressing the need for security, delivery safety, and technological integration, the device delivers a comprehensive solution to the problems associated with modern package delivery.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a combination mailbox and storage locker device that provides a secure storage solution for mail and packages, suitable for residential and business use. The device is comprised of a storage locker body, available in various shapes, and configurable for above ground or underground installation. Underground models feature a reinforced composite or metal structure resistant to environmental wear, while above-ground models may include customizable decorative panels made of durable, weather-resistant materials.

The device includes a lid attached to the locker body via hinges, a locking mechanism, and a hydraulic arm for automated operation. Locking mechanisms include electronic keypads for programming access codes or manual alternatives like tumbler or combination locks. The lid incorporates waterproof gaskets to protect contents from water and debris.

The mailbox top attaches securely to the locker body via detachable fasteners and features a mail slot angled to prevent debris entry. The mail slot directs items to a secondary compartment, while larger packages are deposited directly into the main compartment via the lid.

An integrated keypad with illuminated keys enables secure access to the locker body. Optional features include a motion-sensing camera and a mobile application for real-time monitoring of deliveries, delivery notifications, and temporary code generation for delivery persons. Power is supplied by an adjustable solar panel with a weather-resistant coating and an internal battery to sustain electronic functions in low-light conditions.

The method of use involves attaching the mailbox top to the locker, configuring the locking mechanism, inserting mail through the mail slot into the secondary compartment, and placing larger packages into the main compartment by opening the lid.

Accordingly, the combination mailbox and storage locker device of the present invention is particularly advantageous as it provides a secure and versatile solution for mail and package storage. More specifically, the storage locker that ensures the protection of packages against theft and environmental factors. The integration of an electronic keypad, motion-sensing camera, and mobile application enables secure access, real-time monitoring, and delivery notifications. Additionally, the modular design and customizable components enhance adaptability to various aesthetic and functional preferences. By addressing the need for security, delivery safety, and technological integration, the device delivers a comprehensive solution to the problems associated with modern package delivery. In this manner, the combination mailbox and storage locker device overcomes the limitations of existing mailboxes and package delivery methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a combination mailbox and storage locker device of the present invention in accordance with the disclosed architecture;

FIG. 2 illustrates a perspective view of one potential embodiment of a combination mailbox and storage locker device of the present invention with the lid open in accordance with the disclosed architecture;

FIG. 3 illustrates a front perspective view of one potential embodiment of a combination mailbox and storage locker device of the present invention with an in-ground locker body in accordance with the disclosed architecture;

FIG. 4 illustrates a graphical view of features of a mobile application of one potential embodiment of a combination mailbox and storage locker device of the present invention in accordance with the disclosed architecture; and

FIG. 5 illustrates a flowchart of a method of using one potential embodiment of a combination mailbox and storage locker device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved package locker that provides secure storage for mail and packages to prevent theft. There also exists a long-felt need in the art for an improved package locker that enhances the safety and convenience of delivery personnel. Moreover, there exists a long-felt need in the art for an improved package locker that incorporates advanced security technologies to allow real-time monitoring and controlled access.

The present invention, in one exemplary embodiment, is comprised of a combination mailbox and storage locker device that offers secure storage for mail and packages, suitable for residential and business applications. The device includes a storage locker body available in multiple shapes and configurable for either above ground or underground installation. Underground versions utilize reinforced composite or metal structures designed to withstand environmental conditions, while above-ground models may feature customizable decorative panels made of durable, weather-resistant materials.

The device features a lid connected to the locker body through hinges, a locking mechanism, and a hydraulic arm for automated operation. Locking mechanisms include options such as electronic keypads for programmable access codes or manual locks like tumblers or combination systems. The lid is equipped with waterproof gaskets to safeguard contents from water and debris.

A mailbox top securely attaches to the locker body using detachable fasteners and includes a mail slot angled to prevent debris ingress. Items deposited through the mail slot are directed to a secondary compartment, while larger packages are placed into the main compartment via the lid.

The device integrates a keypad with illuminated keys for secure access. Additional features include a motion-sensing camera and a mobile application that provides real-time delivery monitoring, notifications, and temporary code generation for delivery personnel. Power is supplied by an adjustable solar panel with a weather-resistant coating, along with an internal battery to support electronic functions in low-light conditions.

The method of use involves attaching the mailbox top to the locker body, setting up the locking mechanism, inserting mail into the secondary compartment through the mail slot, and depositing larger packages into the main compartment by opening the lid.

The combination mailbox and storage locker device provides a secure and adaptable solution for mail and package storage, as it protects packages from theft and environmental damage while incorporating an electronic keypad, motion-sensing camera, and mobile application for secure access, monitoring, and notifications. The modular design and customizable components allow for various aesthetic and functional preferences. By addressing security, delivery safety, and technological needs, the invention overcomes the limitations of traditional mailboxes and package delivery systems.

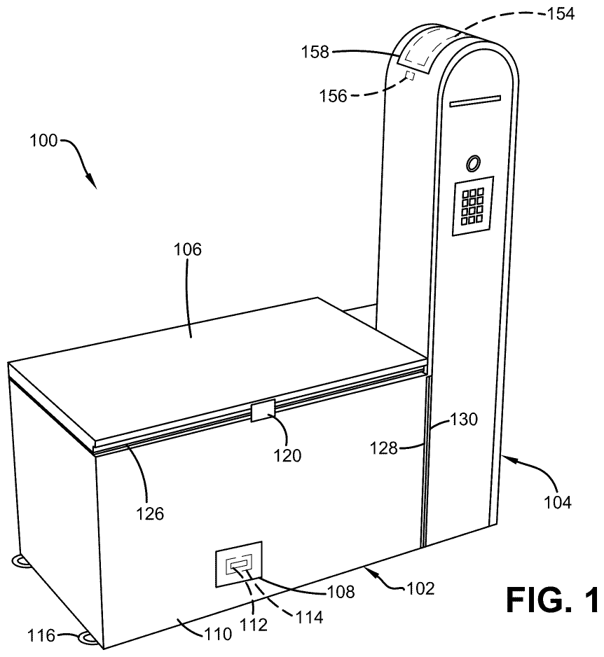

Referring initially to the drawings, FIG. 1 illustrates a perspective view of one potential embodiment of a combination mailbox and storage locker device 100 of the present invention in accordance with the disclosed architecture. The combination mailbox and storage locker device 100 provides a secure mail and package storage solution designed to meet the needs of both homeowners and businesses. The device 100 is comprised of a storage locker body 102, which serves as the primary compartment for holding mail and packages. The locker 102 is preferably square or rectangular in shape but may be designed in other shapes, including but not limited to cylindrical, polygonal, or irregularly contoured forms, based on specific design preferences or installation requirements. The locker 102 may be configured in various embodiments, including both underground and above-ground installations, depending on the desired level of visibility and aesthetic considerations.

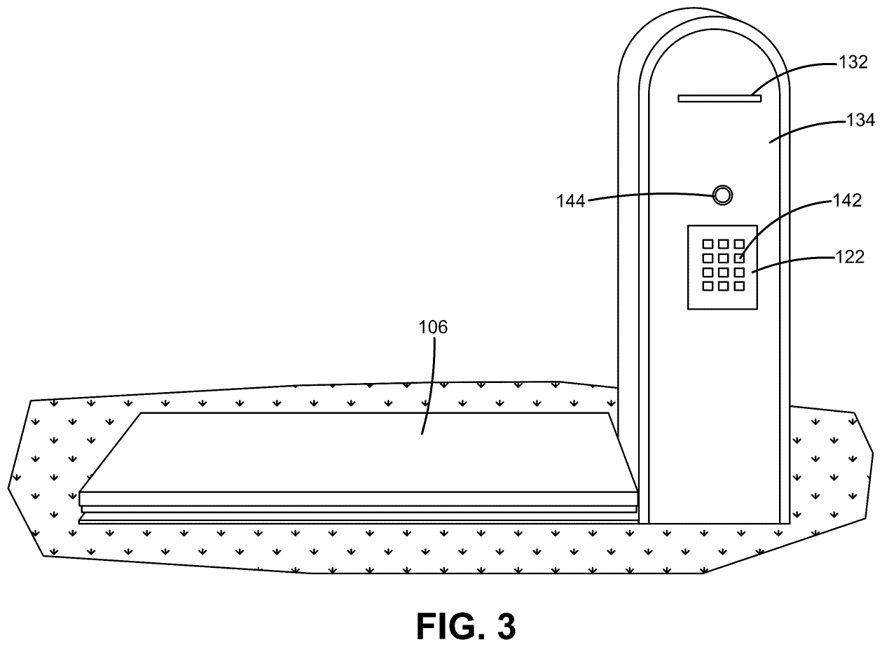

The underground embodiment of the locker 102 is designed for discreet placement, with only a mailbox top 104 and a flush-mounted lid 106 visible above ground, as seen in FIG. 3. This embodiment is particularly suited for applications where maintaining a minimal visual footprint is preferred. The underground locker 102 is preferably comprised of a reinforced composite material and/or metal material engineered to resist soil compression, moisture infiltration, and environmental wear. The composite material is resistant to degradation from temperature fluctuations, corrosion due to soil acidity, and damage resulting from freezing and thawing cycles. The reinforced composite material may incorporate structural additives, such as fiberglass or carbon fiber, to enhance tensile strength and impact resistance.

Above-ground embodiments of the locker 102 may include customizable decorative panels 108 that enhance the aesthetic appeal of the device 100. These panels 108 are manufactured from weather-treated materials, such as fiber-reinforced polymers, anodized aluminum, or treated wood composites, to provide durability and resistance to prolonged exposure to environmental elements. The decorative panels 108 may be designed to replicate the appearance of natural textures, including but not limited to stone, brick, or wood grain. The panels 108 are affixed to the exterior surface 110 of the locker 102, lid 106, and/or mailbox top 104 using concealed fasteners 112,114, which may include tongue-and-groove connectors, adhesive-backed locking systems, or threaded anchors. The concealed fasteners 112,114 ensure a seamless appearance while enabling the replacement or customization of panels 108. The above-ground embodiment may also include adjustable anchoring feet 116, which are designed to provide stability on uneven surfaces such as gravel, cobblestones, or sloped concrete.

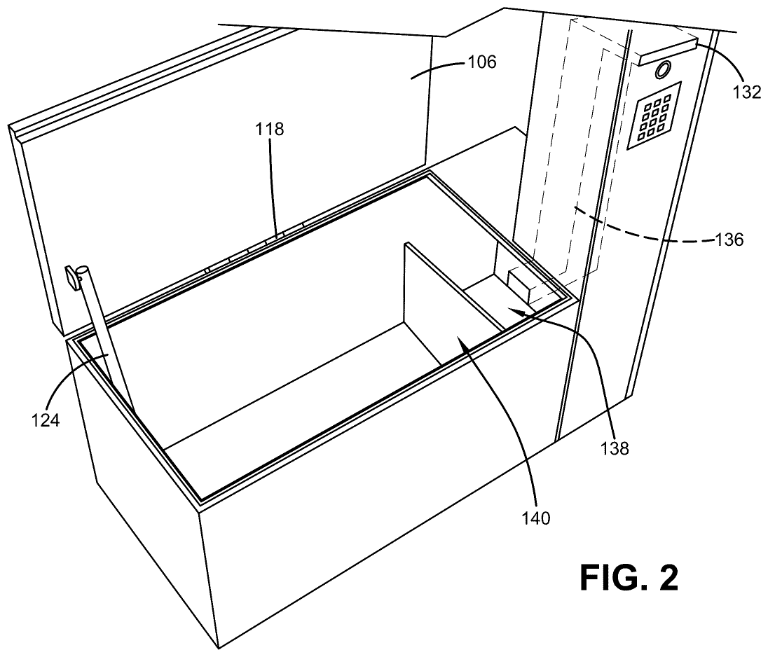

The lid 106 attaches to the locker body 102 via at least one hinge 118 as seen in FIG. 2, which may include concealed pin hinges, continuous piano hinges, or torsion spring hinges, depending on the desired balance of aesthetics and functionality. The lid 106 is secured using at least one locking mechanism 120, which may vary based on the specific embodiment. In one embodiment, the locking mechanism 120 is an electronic system controlled by a keypad 122. This electronic mechanism allows users to program unique access codes, ensuring secure yet convenient access. Alternative embodiments of the locking mechanism 120 may include manual systems, such as key-operated tumbler locks, combination locks, or rotary latch systems. The lid 106 is further attached to the locker 102 via at least one hydraulic arm 124. The hydraulic arm 124 is preferably motorized to facilitate the automatic opening and closing of the lid 106 in response to the locking or unlocking of the mechanism 120. To maintain the integrity of stored items, the locker 102 includes at least one waterproof gasket 126 that seals the perimeter of the lid 106, preventing water, dust, and debris from entering the locker 102.

The mailbox top 104 of the combination mailbox and storage locker device 100 is modular in design, allowing for detachable attachment to the locker 102. The attachment between the locker 102 and mailbox top 104 is facilitated by a pair of reciprocating fasteners 128,130, which may include tongue-and-groove systems, male-and-female couplings, or magnetic connections. These fasteners 128,130 ensure secure yet detachable connections to allow for easy replacement or customization. The mailbox top 104 may be manufactured in various shapes and styles, ranging from traditional mailbox designs to ornamental figures or geometric forms. Customization options may include designs that replicate logos, characters, objects, natural structures, etc.

The mailbox top 104 is further comprised of a mail slot 132 designed for the secure delivery of letters and small parcels. The mail slot 132 is preferably positioned at a slight downward angle of approximately 15 degrees relative to the front surface 134 of the mailbox top 104. This angled orientation prevents rain, snow, and debris from entering the mail slot 132, thereby ensuring the protection of mail. The mail slot 132 includes an internal channel 136 that directs letters and small parcels into a secondary compartment 138 within the locker 102, as seen in FIG. 2. The channel 136 may be sloped or curved to optimize the distribution of mail into the appropriate section of the locker 102. Larger packages may bypass the mail slot 132 and be deposited directly into the main compartment 140 of the locker 102 via the lid 106.

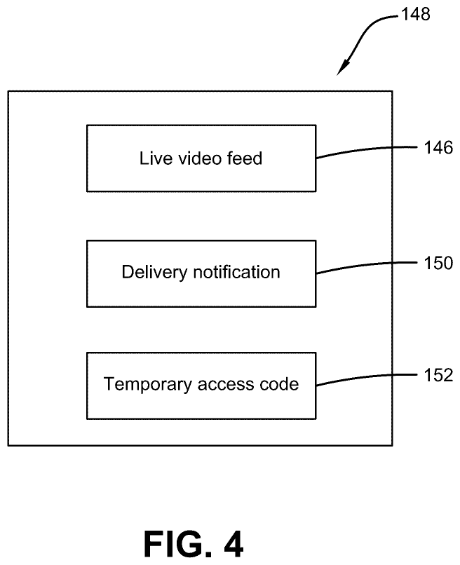

The electronic keypad 122 integrated into the device 100 features illuminated keys 142, ensuring visibility and ease of use in low-light conditions. The keypad 122 enables users to program unique access codes for multiple individuals and assign temporary codes for delivery personnel. The device 100 may further include a motion-sensing camera 144, which provides real-time monitoring capabilities. The camera 144 is configured to deliver a live video feed 146 accessible through a mobile application 148. The mobile application 148 also delivers delivery notifications 150 triggered by events such as the opening of the lid 106 or the insertion of mail into the slot 132, as seen in FIG. 4. Additionally, the mobile application 148 may generate temporary access codes 152 for the electronic keypad 122 as seen in FIG. 4, allowing secure package delivery by authorized personnel.

The device 100 is powered by at least one solar panel 154 that is positionally adjustable to optimize sunlight capture, as seen in FIG. 1. The solar panel 154 supplies energy to an internal battery 156, which stores sufficient power to operate all electronic components of the device 100, even in low-light conditions. The solar panel 154 is integrated into the mailbox top 104 and is protected by a weather-resistant, scratch-proof coating 158 to ensure long-term functionality and durability.

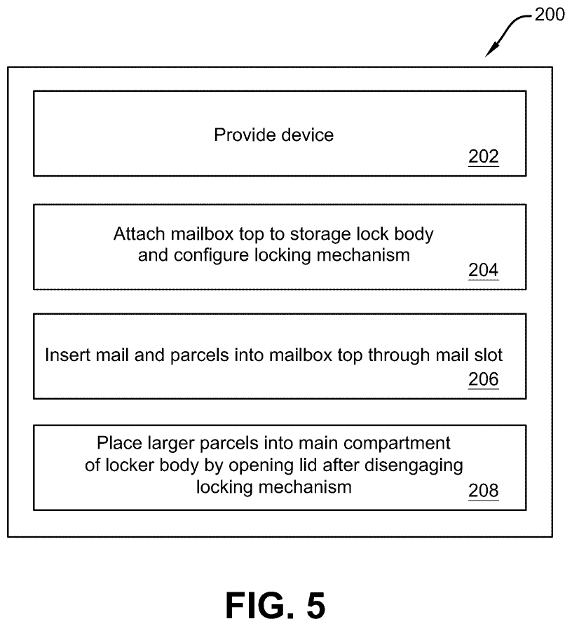

The present invention is also comprised of a method of using 200 the combination mailbox and storage locker device 100, as seen in FIG. 5. First, a combination mailbox and storage locker device 100 is provided, comprising a storage locker body 102, at least one mailbox top 104, at least one lid 106, and at least one locking mechanism 120 [Step 202]. Then, the mailbox top 104 can be attached to the storage locker body 102 using reciprocating fasteners 128,130, and the locking mechanism 120 can be configured for secure access via a keypad 122 [Step 204]. Next, mail and small parcels can be inserted into the mailbox top 104 through the mail slot 132, where the mail slot 132 directs the items into a secondary compartment 138 within the storage locker body 102 [Step 206]. Larger parcels can be placed directly into the main compartment 140 of the locker body 102 by opening the lid 106 after disengaging the locking mechanism 120 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “combination mailbox and storage locker device” and “device” are interchangeable and refer to the combination mailbox and storage locker device 100 of the present invention.

Notwithstanding the forgoing, the combination mailbox and storage locker device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the combination mailbox and storage locker device 100 as shown in the FIGS. are for illustrative purposes only, and that many other sizes and shapes of the combination mailbox and storage locker device 100 are well within the scope of the present disclosure. Although the dimensions of the combination mailbox and storage locker device 100 are important design parameters for user convenience, the combination mailbox and storage locker device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A combination mailbox and storage locker device comprising:
a locker body comprised of a lid and a locking mechanism that secures the lid to the body;
a keypad;
a solar panel; and
a mailbox top that attaches to the locker, the mailbox top comprised of a mail slot.

2. The combination mailbox and storage locker device of claim 1, wherein the locker is comprised of a composite material that resists soil compression, moisture infiltration, and environmental wear.

3. The combination mailbox and storage locker device of claim 1, wherein the mailbox is comprised of a decorative panel.

4. The combination mailbox and storage locker device of claim 3, wherein the decorative panel resembles a stone, a brick, or a wood grain.

5. The combination mailbox and storage locker device of claim 1, wherein the locker is comprised of a foot.

6. The combination mailbox and storage locker device of claim 1, wherein the lid is attached to the locker body via a hinge.

7. The combination mailbox and storage locker device of claim 1, wherein keypad controls a locking and an unlocking of the locking mechanism.

8. The combination mailbox and storage locker device of claim 1, wherein the lid is attached to the locker body via a motorized hydraulic arm.

9. A combination mailbox and storage locker device comprising:
a locker comprised of a lid, a gasket, and a locking mechanism that secures the lid to the body;
a keypad;
a camera;
a solar panel; and
a mailbox top that attaches to the locker, the mailbox top comprised of a mail slot.

10. The combination mailbox and storage locker device of claim 9, wherein the mail slot is comprised of an angled slot.

11. The combination mailbox and storage locker device of claim 9, wherein the solar panel is positioned on the mailbox top.

12. The combination mailbox and storage locker device of claim 9, wherein the keypad is positioned on the mailbox top.

13. The combination mailbox and storage locker device of claim 9, wherein the camera is comprised of a motion-sensing camera.

14. The combination mailbox and storage locker device of claim 9, wherein the camera delivers a live video feed to a mobile application.

15. The combination mailbox and storage locker device of claim 14, wherein the camera delivers a notification to the mobile application.

16. The combination mailbox and storage locker device of claim 14, wherein the mobile application generates a temporary access code to the locking mechanism that can be inputted into the keypad.

17. The combination mailbox and storage locker device of claim 9 further comprised of an internal battery.

18. The combination mailbox and storage locker device of claim 9, wherein the mailbox top is comprised of a first fastener that attaches to a second fastener of the locker body.

19. The combination mailbox and storage locker device of claim 9, wherein the locker body is comprised of a secondary compartment in communication with the mail slot via an internal channel.

20. A method of using a combination mailbox and storage locker device, the method comprising the following steps:
providing a combination mailbox and storage locker device comprised of a locker body comprised of a lid and a locking mechanism, and a mailbox top attached to the locker body;
configuring the locking mechanism for secure access via a keypad;
inserting a mail or a small parcel into the mailbox top through a mail slot, wherein the mail slot directs the mail or the small parcel into a secondary compartment within the locker body; and
placing a larger parcel into a main compartment of the storage locker body by opening the lid after disengaging the locking mechanism via the keypad.
